(19) United States
(12) Patent Application Publication
(10) Pub. No.: US 2026/0320966 A1
(43) Pub. Date: Oct. 15, 2026

(54) IMAGE PRE-PROCESSING SYSTEM AND METHOD

(71) Applicant: LITE-ON TECHNOLOGY CORPORATION, TAIPEI CITY (TW)

(72) Inventors: Tsung-Hung TSAI, TAIPEI CITY (TW); Kun Da LIN, TAIPEI CITY (TW); TseChun WANG, TAIPEI CITY (TW)

(21) Appl. No.: 19/311,586

(22) Filed: Aug. 27, 2025

Related U.S. Application Data
(60) Provisional application No. 63/788,180, filed on Apr. 14, 2025.
(60) Provisional application No. 63/832,540, filed on Jun. 30, 2025.

(51) Int. Cl. G06V 10/72; G06V 10/774; G06V 10/776

(52) U.S. Cl. CPC G06V 10/72; G06V 10/7747; G06V 10/776

(57) ABSTRACT

An image pre-processing system is provided for optimizing model performance across varying camera sources. The system includes a reference image-capturing device, a processing unit, and a storage unit storing instructions to train a machine learning model using a training dataset. The system obtains multiple validation datasets, analyzes relationships between image statistics and performance metrics, selects a subset of image statistics based on the analysis, and pre-processes target images from a target device using the selected statistics.

### CROSS REFERENCE TO RELATED APPLICATIONS

This application claims the benefit of U.S. provisional application No. 63/788,180, filed Apr. 14, 2025 and U.S. Provisional Application No. 63/832,540, filed Jun. 30, 2025. The entirety of each of these applications is incorporated by reference herein.

### TECHNICAL FIELD

The present disclosure relates to an image pre-processing system, and, in particular, it relates to an image pre-processing system for model performance optimization.

### BACKGROUND

Currently, fields such as surveillance and autonomous driving rely on modern object detection technology. However, due to the differences in image statistics among various camera modules, the performance of a specific object detection model may suffer when the model and its weights are applied to image datasets from different cameras. This drop in performance is typically caused by changes in image statistics. To improve overall performance, model fine-tuning on the camera's image data is usually required, which is time-consuming and increases costs.

A commonly used solution that has been used to address this issue is model fine-tuning. This involves performing supervised learning on a set of images captured by the customer’s specific camera. In this process, the pre-trained model is retrained using labeled data from the target camera, allowing the model parameters to adapt to the statistical characteristics of the new image source. While this approach can improve the detection accuracy of the target camera, it has several drawbacks. First, collecting and labeling sufficient training data from the customer’s camera can be labor-intensive and time-consuming. Second, the fine-tuning process itself requires computational resources and expertise, which may not be readily available in deployment environments. Third, frequent fine-tuning across different devices and camera configurations increases the operational costs and complicates model maintenance.

Therefore, an image pre-processing system and method is needed to address the above issues.

### BRIEF SUMMARY

An embodiment of the present disclosure provides an image pre-processing system for model performance optimization. The system comprises a reference image-capturing device configured to capture a training dataset and a reference validation dataset, a processing unit in communication with the reference image-capturing device, and a storage unit storing a computer program. The computer program includes instructions that, when executed by the processing unit, cause the processing unit to perform the following operations. A machine learning model is trained using the training dataset captured by the reference image-capturing device. A plurality of validation datasets is obtained, wherein the validation datasets include the reference validation dataset and a plurality of target validation datasets. The relationships between image statistics and performance metrics are analyzed, wherein the image statistics are derived from the validation datasets, and the performance metrics are generated using the machine learning model. A subset of the image statistics is selected based on the analyzed relationships. Target images captured by a target image-capturing device are pre-processed based on the selected subset of the image statistics.

In some embodiments, the image pre-processing system further includes functionality for analyzing the relationships between image statistics and performance metrics. The processing unit is configured to perform operations including the following. For each of the validation datasets, the processing unit applies the trained machine learning model to compute a corresponding performance metric, and computes image statistics from the images within the respective validation dataset. For each image statistic, the difference between the representative value derived from the reference validation dataset and another representative value derived from each target validation dataset is computed. The processing unit is further configured to compute the correlation between the computed differences and the performance metrics across the target validation datasets. The resulting correlation is used to represent the relationship between the respective image statistic and the performance metrics.

In some embodiments, the image pre-processing system further enables selection of a subset of image statistics based on their relevance to model performance. The processing unit is configured to execute the following steps. The image statistics are ranked based on correlations between the computed differences and the corresponding performance metrics across the target validation datasets to identify a candidate subset. The image statistics within the candidate subset are adjusted to approximate target values within respective tolerance ranges. Each adjusted image statistic is evaluated to determine whether the corresponding performance metrics associated with validation datasets adjusted within the tolerance range exceed a predefined threshold. Those for which the associated performance metrics exceed the predefined threshold are selected as the final subset of image statistics.

In some embodiments, the image pre-processing system includes the functionality to refine the selection of image statistics based on statistical robustness and visualization techniques. The processing unit may be further configured to evaluate each image statistic in the candidate subset using a coefficient of variation (CV), and to exclude any image statistic having a CV exceeding a predefined threshold.

In some embodiments, the system further supports visualization-assisted evaluation. The processing unit may be configured to generate a visual representation of the relationship between each image statistic and the corresponding performance metric across the validation datasets, and to display the visual representation on a display device for review or interpretation.

In some embodiments, the correlation between the computed differences and the performance metrics may be calculated using Spearman’s Rank Order Correlation Coefficient (SROCC), thereby enabling robust assessment of monotonic relationships between image statistics and model performance.

In some embodiments, the image pre-processing system supports the use of multiple image-capturing devices, wherein the target validation datasets are captured by different image-capturing devices, thereby enabling evaluation across device variability. In certain other embodiments, the target validation datasets are generated by applying a variety of image signal processing (ISP) parameters to raw images captured by the reference image-capturing device, allowing simulation of diverse image conditions during validation.

In some embodiments, the processing unit is configured to apply the trained machine learning model to pre-processed target images to perform inference, wherein the parameters used in the pre-processing are adjusted to reduce differences between the image statistics of the target images and those of the images captured by the reference image-capturing device, thereby optimizing inference performance.

In some embodiments, the image pre-processing system may be configured to perform scenario-specific selection of image statistics, wherein different subsets of the image statistics are selected for respective image-capturing scenarios, each corresponding to a particular condition under which the target images are captured.

In some embodiments, the image pre-processing system enables scenario-specific selection and adjustment of image statistics. For example, luminance-related statistics may be selected for low-light scenarios, while saturation-related statistics may be selected for dusk scenarios. The processing unit may be further configured to classify the image-capturing scenario by computing a luminance mean and a saturation standard deviation from the target images, comparing these values to respective predefined thresholds, and determining whether the image-capturing scenario corresponds to low-light or dusk conditions based on the comparison results.

In some embodiments, the processing unit is also configured to identify one or more image statistics associated with a given image-capturing scenario and adjust these statistics to reduce differences between the target images and the reference validation dataset.

In some embodiments, the image statistics may include at least one of the following: color characteristics, texture characteristics, brightness level, contrast, sharpness indicators, and non-reference image quality assessment (NR-IQA) metrics.

In some embodiments, the parameters used for pre-processing the target images may include at least one of the following: gamma correction, contrast enhancement, sharpening level, and noise reduction strength.

An embodiment of the present disclosure provides a computer-implemented method for optimizing model performance via image pre-processing. The method comprises training a machine learning model using a training dataset captured by a reference image-capturing device. The method comprises obtaining a plurality of validation datasets, wherein the validation datasets include a reference validation dataset captured by the reference image-capturing device and a plurality of target validation datasets. The method comprises analyzing relationships between image statistics and performance metrics, wherein the image statistics are derived from the validation datasets, and the performance metrics are derived from the validation datasets using the trained machine learning model. The method comprises selecting a subset of the image statistics based on the analyzed relationships. The method comprises pre-processing target images captured by a target image-capturing device based on the selected subset of image statistics.

In some embodiments, the computer-implemented method further comprises analyzing the relationships between the image statistics and the performance metrics by performing the following steps. For each of the validation datasets, the trained machine learning model is applied to compute the performance metric, and image statistics are computed from images within the validation dataset. For each image statistic, the difference between a representative value derived from the reference validation dataset and a representative value derived from each target validation dataset is computed. The correlation between the computed differences and the performance metrics across the target validation datasets is computed. The computed correlation is used to represent the relationship between the image statistic and the performance metrics.

In some embodiments, the method further comprises selecting the subset of the image statistics by performing the following steps. One step ranks the image statistics based on the correlations between the computed differences and the corresponding performance metrics across all the target validation datasets to identify a candidate subset. One step adjusts the image statistics within the candidate subset to approximate target values within respective tolerance ranges. For each adjusted image statistic, one step determines whether the corresponding performance metrics associated with validation datasets adjusted within the tolerance range exceed a predefined threshold. One step selects those for which the corresponding performance metrics exceed the predefined threshold, for use as the final subset of image statistics.

In some embodiments, the method further comprises evaluating each image statistic in the candidate subset using a coefficient of variation (CV), and excluding any image statistic having a CV that exceeds a predefined threshold.

In some embodiments, the method further comprises generating a visual representation of the relationship between each image statistic and the corresponding performance metric across the validation datasets, and displaying the visual representation on a display device.

In some embodiments, the correlations between the computed differences and the performance metrics are calculated using Spearman’s Rank Order Correlation Coefficient (SROCC), enabling robust evaluation of monotonic relationships.

In some embodiments, the target validation datasets may be captured by multiple image-capturing devices, allowing the method to account for device-level variation in image characteristics.

In some embodiments, the method further comprises obtaining the target validation datasets by applying a variety of image signal processing (ISP) parameters to raw images captured by the reference image-capturing device, thereby enabling the simulation of diverse image conditions.

In additional embodiments, the method includes applying the trained machine learning model to the pre-processed target images to perform inference, wherein parameters used for pre-processing are adjusted to reduce differences between the image statistics of the target images and those of images captured by the reference image-capturing device.

In further embodiments, respective subsets of the image statistics are selected for respective image-capturing scenarios, where each scenario corresponds to a particular condition in which the target images are captured. For example, luminance-related statistics may be selected for low-light scenarios, while saturation-related statistics may be selected for dusk scenarios.

In some embodiments, the method further comprises classifying the image-capturing scenario by computing a luminance mean and a saturation standard deviation from the target images, comparing the computed values to respective predefined thresholds, and determining whether the image-capturing scenario corresponds to low-light scenarios or dusk scenarios based on the comparison results.

In some embodiments, the method further includes identifying one or more image statistics associated with the determined image-capturing scenario and adjusting the identified statistics to reduce differences between the target images and the reference validation dataset.

Additionally, the image statistics may include at least one of the following: color characteristics, texture characteristics, brightness level, contrast, sharpness indicators, and non-reference image quality assessment (NR-IQA) metrics.

Furthermore, the parameters used to pre-process the target images may include at least one of the following: gamma correction, contrast enhancement, sharpening level, and noise reduction strength.

### BRIEF DESCRIPTION OF THE DRAWINGS

The present disclosure can be more fully understood by reading the subsequent detailed description and examples with references made to the accompanying drawings, wherein:

FIG. 1 shows an image pre-processing system for model performance optimization;

FIG. 2A shows a flow diagram of an image pre-processing method, according to an embodiment of the present disclosure;

FIG. 2B a dataflow of an image pre-processing method, according to an embodiment of the present disclosure;

FIG. 3 shows a relationship between an image statistic and the corresponding performance metrics across different validation dataset;

FIG. 4 shows the distribution of a relationship between differences in image statistics and the corresponding performance of a machine learning model;

FIG. 5 shows a graph illustrating an example of the application of Spearman’s Rank Order Correlation Coefficient (SROCC) to evaluate the relationship between variations in image statistics and model performance;

FIG. 6 shows a flow diagram illustrating a process for selecting a subset of image statistics; and

FIG. 7 is a diagram illustrating a ranking of image statistics based on their evaluation using Spearman’s Rank Order Correlation Coefficient (SROCC).

### DETAILED DESCRIPTION

The following description is made for the purpose of illustrating the general principles of the disclosure and should not be taken in a limiting sense. The scope of the disclosure is best determined by reference to the appended claims.

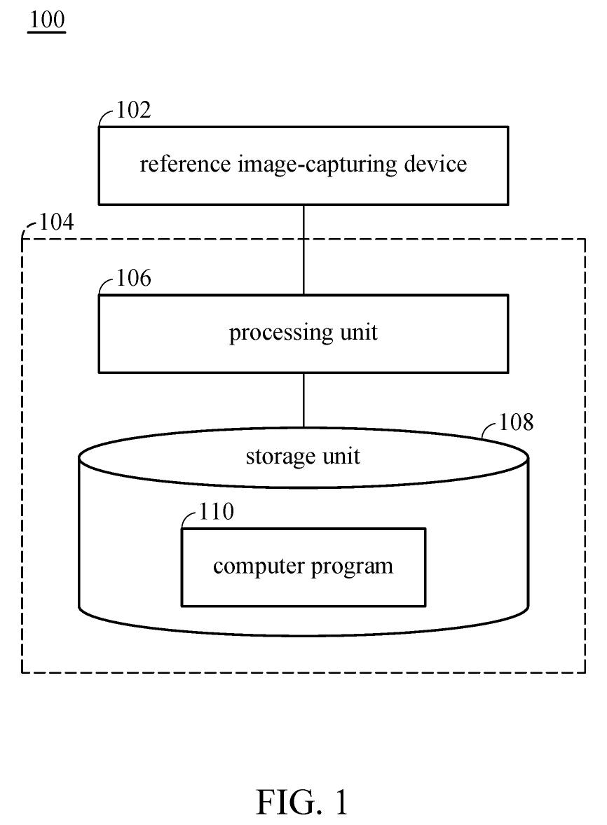

FIG. 1 shows an image pre-processing system 100 for model performance optimization, according to an embodiment of the present disclosure. As show in FIG. 1, the image pre-processing system 100 may include a reference image-capturing device 102 and a computer device 104. The computer device 104 may include a processing unit 106 and a storage unit 108. A computer program 110 may be stored in the storage unit 108. The processing unit 106 may communicate with the reference image-capturing device 102 via wired or wireless connections. The processing unit 106 may be connected to the storage unit via wired or wireless connections to execute the computer program stored in it.

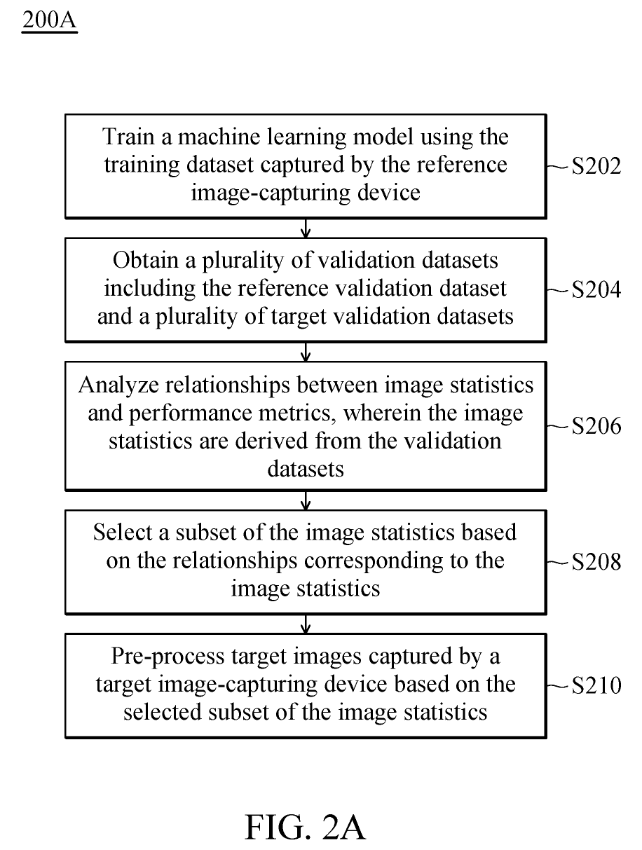

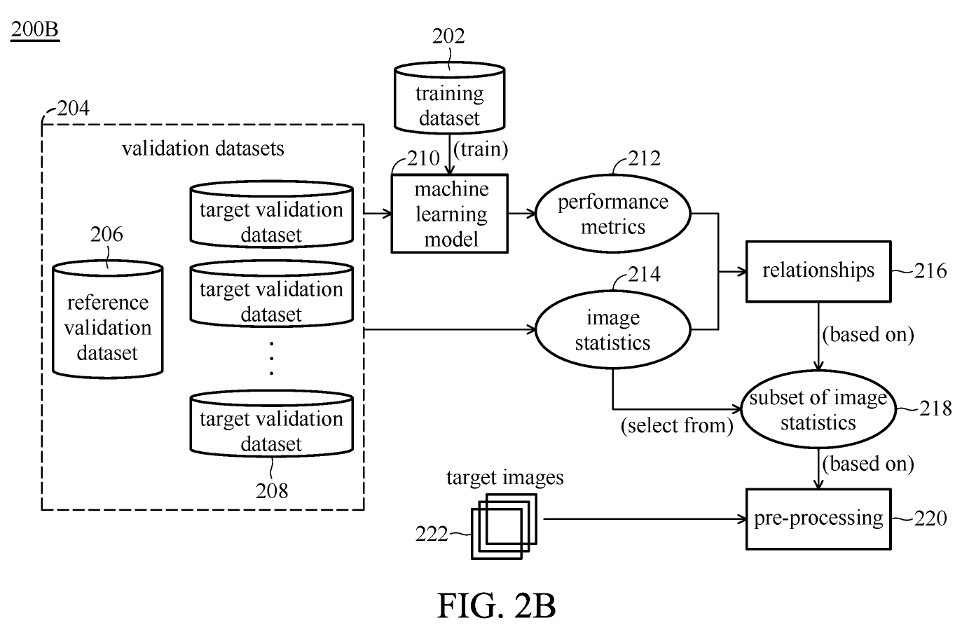

The reference image-capturing device 102 is a physical device configured to capture a plurality of images and transmit the captured images to the computer device 104 as training datasets and reference validation datasets. In the embodiments of the present disclosure, the processing unit 106 may execute the computer program 110 stored in the storage unit 108 to perform steps illustrated in FIG. 2A.

The reference image-capturing device 102 be configured to acquire one or more reference images for use in image analysis or pre-processing. The reference image-capturing device 102 may include, for example, a digital camera, a charge-coupled device (CCD), a complementary metal-oxide semiconductor (CMOS) image sensor, or other types of image sensors capable of capturing still or dynamic image data. In some implementations, the reference image-capturing device 102 may be integrated into a mobile device, an industrial inspection system, or a standalone camera module, but the present disclosure is not limited thereto.

The computer device 104 may include but not limited to a desktop computer, a laptop computer, a tablet, a smartphone, a cloud computing platform, or a server. The computer device 104 may be configured to execute software applications and perform processing tasks related to image capture, pre-processing, and analysis. In some embodiments, the computer device 104 may include both local and remote components connected via a communication network, such as the Internet or a local area network (LAN).

The processing unit 106 may include a central processing unit (CPU), a graphics processing unit (GPU), a digital signal processor (DSP), a field-programmable gate array (FPGA), an application-specific integrated circuit (ASIC), or a combination thereof. The processing unit 106 is configured to execute instructions provided by a computer program and perform the computational tasks required to carry out the image pre-processing method described herein. The specific type of processing unit may be selected based on performance requirements, power consumption constraints, or application-specific considerations.

The storage unit 108 may be configured to store data, programs, or intermediate processing results. The storage unit 108 may include any type of computer-readable storage medium, such as a hard disk drive (HDD), a solid-state drive (SSD), a memory card, flash memory, or optical storage media. In certain embodiments, the storage unit 108 may include volatile memory (e.g., DRAM) or non-volatile memory (e.g., NAND flash), and may reside locally on the computer device 104 or be accessible via a remote server or cloud storage.

The computer program 110 may include a set of instructions, modules, or scripts stored in the storage unit 108 and executed by the processing unit 106. The computer program 110 may be implemented in any suitable programming language, such as Python, C, C++, Java, or MATLAB, but the present disclosure is not limited thereto. In some embodiments, the computer program 110 may be developed using a combination of high-level and low-level languages, or may utilize existing libraries and frameworks for image processing or machine learning. The image pre-processing method implemented by the computer program 110 will be described in detail below with reference to FIGS. 2A and 2B.

FIG. 2A illustrates a flow diagram of an image pre-processing method 200A, according to an embodiment of the present disclosure. FIG. 2B shows a dataflow 200B of the image pre-processing method 200A, according to an embodiment of the present disclosure. In some embodiments, the image pre-processing method 200A is implemented by the image pre-processing system 100 described above. For a better understanding of the present disclosure, FIGS. 2A and 2B may be referred to together. As shown in FIG. 2A, method 200A includes steps S202-S210. These steps will be described in detail below.

Method 200A starts in step S202. In step S202, a machine learning model 210 is trained by the reference image-capturing device (e.g., the reference image-capturing device 102 in FIG. 1) using the training dataset 202.

The machine learning model 210 may include, for example, YOLOv9, a convolutional neural network (CNN), a support vector machine (SVM), a decision tree, a random forest, or any other suitable supervised or unsupervised learning model. In certain embodiments, the machine learning model 210 may be configured to perform various image-related tasks such as image classification, segmentation, object detection, enhancement, or depth estimation, but the present disclosure is not limited thereto.

The training dataset 202 may include a plurality of labeled or unlabeled images captured under various imaging conditions, such as different lighting, exposure levels, and object positions. In some embodiments, the training dataset 202 may include ground truth data for supervised learning, or it may be used in an unsupervised or semi-supervised learning framework. During the training process, the model 210 may be optimized using known machine learning algorithms such as stochastic gradient descent (SGD), Adaptive Moment Estimation (Adam), or other optimization techniques. Once trained, the model 210 may be used to perform various image-related tasks such as image classification, segmentation, object detection, enhancement, or depth estimation.

In step S204, the processing unit 106 obtains a plurality of validation datasets 204, including a reference validation dataset 206 and a plurality of target validation datasets 208. The reference validation dataset 206 may be generated by the reference image-capturing device (e.g., reference image-capturing device 102 in FIG. 1) under controlled or standard conditions, and serves as a baseline for evaluating model performance.

In contrast, the target validation datasets 208 are used as analysis targets to assess how the trained machine learning model performs under various imaging conditions or hardware configurations. These datasets are intended to reflect diverse real-world scenarios and, ideally, should encompass a wide range of conditions to ensure the generalizability and robustness of the trained model. Such diversity helps identify performance degradation or bias when the model is exposed to images captured under non-ideal or shifted conditions.

In some embodiments, the target validation datasets 208 are captured by multiple image-capturing devices. Different devices may have varying sensor types, lens characteristics, internal image processing pipelines, or other hardware factors, all of which can affect the resulting image quality and characteristics.

By incorporating validation datasets from various devices, the system can evaluate the generalization capability and robustness of the trained machine learning model 210. This diversity allows the model to be assessed under conditions that more closely resemble real-world deployment scenarios, where images may come from heterogeneous sources. Consequently, this step helps ensure that the model does not overfit to the reference device’s image statistics and remains reliable across different hardware platforms.

In some embodiments, the target validation datasets 208 are obtained by applying a variety of image signal processing (ISP) parameters to raw images captured by the reference image-capturing device 102. In this scenario, instead of relying on multiple physical devices, a single set of raw image data is processed multiple times using different ISP configurations. These ISP parameters may include, for example, white balance gains, gamma correction settings, sharpening levels, noise reduction strengths, tone-mapping curves, or other image pipeline parameters.

By varying the ISP parameters, multiple versions of processed images may be generated from the same raw image data, thereby enabling the system to evaluate how different image statistics affect model performance. Such an approach is particularly useful in early-stage development or simulation environments where access to a wide range of physical devices may be limited. It also facilitates more systematic testing by isolating the effect of specific ISP settings on model behavior.

In step S206, the processing unit 106 analyzes relationships 216 between performance metrics 212 and image statistics 214. The image statistics 214 are derived from the validation datasets and the performance metrics 212 are obtained by applying the machine learning model 210 to the same validation datasets.

The image statistics 214 may include but not limited to color characteristics, texture characteristics, brightness level, contrast, sharpness indicators, and non-reference image quality assessment (NR-IQA) metrics. These image statistics may be extracted using standard image processing techniques, such as histogram analysis, edge detection, frequency domain analysis (e.g., Fourier transform), or noise estimation algorithms. In some embodiments, deep-learning-based feature extractors may also be used to generate higher-level image descriptors as part of the image statistics, but the present disclosure is not limited thereto.

The performance metrics 212 are derived by using the trained machine learning model 210 to perform inference or prediction on the validation datasets 204, and then measuring the effectiveness of the model output. For example, the model may perform classification, detection, or enhancement tasks on each image in the validation datasets 204, and the resulting outputs may be compared to ground truth labels or reference results to compute performance. These performance metrics may include, but are not limited to, mean average precision (mAP), accuracy, precision, recall, F1-score, peak signal-to-noise ratio (PSNR), structural similarity index measure (SSIM), or inference latency. The selection of specific performance metrics may depend on the task that the model is designed to perform.

In step S208, the processing unit 106 selects a subset of the image statistics 218 based on the relationships 216 corresponding to the image statistics 214. These relationships 216 represent the degree of correlation or association between individual image statistics and the performance metrics 212. In other words, the processing unit 106 evaluates how strongly variations in each image statistic affect the performance of the trained machine learning model.

By identifying image statistics with stronger relationships to model performance, the system can prioritize those statistics that are more influential in determining inference accuracy or robustness. A higher degree of correlation typically indicates that the corresponding image statistic has a greater impact on the model's behavior. Selecting a meaningful subset of the image statistics 218 helps focus subsequent processing or optimization efforts on the most relevant features, improving efficiency and performance stability across different deployment conditions.

In some embodiments, each of the correlations between the computed differences in image statistics and the corresponding performance metrics may be calculated using Spearman’s Rank Order Correlation Coefficient (SROCC). SROCC is particularly suited for measuring monotonic relationships between non-normally distributed variables. In some other embodiments, other correlation or association measures may be used, such as Pearson’s correlation coefficient, Kendall’s tau coefficient, mutual information, or distance correlation. The choice of metric may depend on the data characteristics or the specific performance criteria being optimized.

In step S210, the processing unit 106 pre-processes target images 222 captured by a target image-capturing device based on the selected subset of the image statistics 218. In this context, pre-processing 220 refers to adjusting the relevant image statistics of the target images to reduce statistical differences compared to those of images captured by the reference image-capturing device. For instance, if brightness, contrast, or sharpness are among the selected image statistics, the system may apply corresponding adjustments to these aspects of the target images.

The target image-capturing device refers to the device used to capture the images intended for inference or deployment in real-world applications. This device may be different from the reference image-capturing device 102, which was used to generate the training dataset 202 or the reference validation dataset 206. Differences between the target and reference devices may include sensor type, lens quality, image signal processing (ISP) pipeline, color filter array, or other optical and hardware parameters. These differences can lead to variations in the resulting image statistics. Such variations may affect the performance of a machine learning model that was trained on data from the reference device.

The image pre-processing 220 performed by the system may involve several adjustable parameters that influence the visual characteristics of the target images prior to further analysis or processing. These parameters may include gamma correction, contrast enhancement, sharpening level, and noise reduction strength, but the present disclosure is not limited thereto.

Gamma correction modifies the luminance levels of the image to improve visibility in regions that are underexposed or overexposed. Contrast enhancement adjusts the difference between light and dark areas to make image features and statistical characteristics more distinguishable. The sharpening level determines the degree to which edges and fine details are emphasized in the image. Noise reduction strength controls the suppression of random or unwanted noise that could interfere with subsequent analysis, such as object detection or feature extraction.

In some embodiments, the processing unit 106 is configured to analyze how different image statistics relate to the performance of a trained machine learning model. To do this, the system follows a series of steps that help quantify the strength and nature of this relationship.

First, for each of the validation datasets, the trained model is applied to perform inference, and corresponding performance metrics are recorded. At the same time, the system also calculates various image statistics from the images in each validation dataset. These statistics may include measures such as contrast, sharpness, brightness, or other visual characteristics.

Next, for every image statistic under consideration, the processing unit compares its value in the reference validation dataset to its value in each of the target validation datasets. This allows the system to calculate the difference for that image statistic between the reference and each target dataset. Then, for each image statistic, the system analyzes how these differences relate to changes in model performance across the target datasets. Specifically, it computes the correlation between the differences in image statistics and the corresponding performance metrics.

This correlation essentially reflects how sensitive the model’s performance is to variations in a particular image statistic. A stronger correlation implies that the statistic in question may play a more significant role in affecting inference accuracy or robustness.

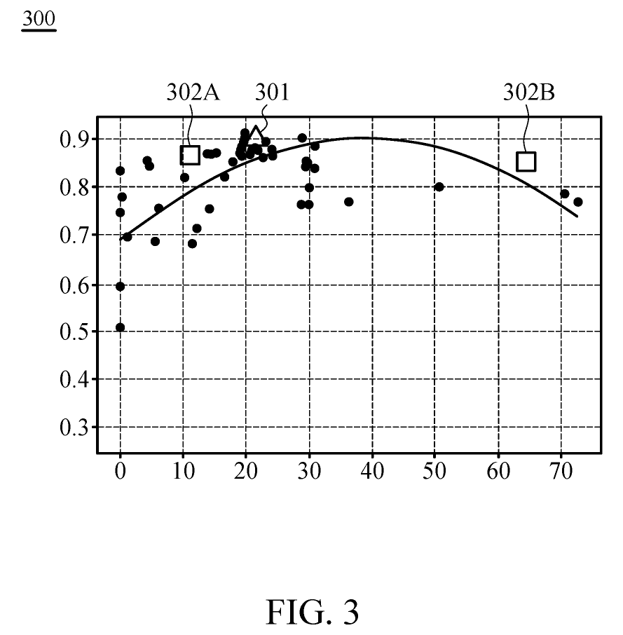

To help illustrate this process and make the relationships easier to visualize, FIG. 3 provides an example of how such correlations can be represented. The figure may include plots or graphs that map changes in image statistics to performance metrics across different datasets, helping identify which statistics most strongly influence model behavior.

Referring to FIG. 3, FIG. 3 illustrates the relationship 300 between an image statistic and the corresponding performance metrics across different validation dataset. For the purpose of illustration, only one image statistic is selected in this example, namely Hue peak, which reflects the dominant color tone distribution in the image.

In FIG. 3, the horizontal axis represents the values of the Hue peak derived from each validation dataset, and the vertical axis represents the corresponding mean Average Precision (mAP) values, which serve as the performance metric for evaluating the trained machine learning model. Each point on the graph represents a pair of values: the computed Hue peak from a specific validation dataset and the mAP value obtained by applying the model to that dataset.

Among the points shown, point 301 corresponds to the reference validation dataset, representing both its Hue peak value and its associated mAP performance. Other points, such as point 302A and point 302B, correspond to different target validation datasets.

From FIG. 3, it can be observed that the closer a target point is to point 301, the more similar its image statistic (i.e., Hue peak value) is to the reference, and typically, the better the model performs on that dataset. For example, point 302A, which lies closer to point 301, shows a higher mAP compared to point 302B, which is farther away. This suggests that the difference in Hue peak between the target and the reference datasets may have contributed to the drop in performance observed in point 302B.

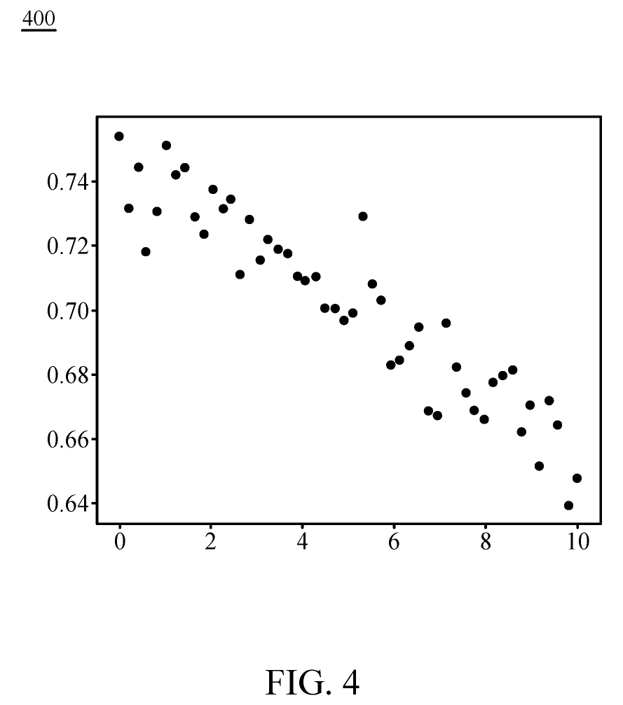

This example highlights how certain image statistics can significantly influence model performance, and visualizing these relationships helps identify which characteristics are more critical. To further quantify such relationships across multiple statistics and datasets, the system may generate correlation scores. FIG. 4 provides an example of such analysis, where a specific image statistic is plotted against model performance to illustrate a measurable relationship.

Referring to FIG. 4, FIG. 4 illustrates the distribution of a relationship 400 between differences in image statistics and the corresponding performance of a machine learning model, as measured by mean Average Precision (mAP). The horizontal axis represents the degree of deviation in one or more image statistics across datasets. The vertical axis represents the resulting mAP values produced by the model when evaluated under these varying conditions.

As illustrated, a negative correlation is observed between the image statistic deviation and the model performance. Specifically, as the deviation increases, the mAP value tends to decrease. This indicates that increased variation in image characteristics may degrade model performance, potentially due to a shift in data distribution between training and evaluation datasets. The affected image statistics may include but not limited to color distribution, brightness, contrast, texture metrics, or other quantifiable visual properties.

The strength and nature of this relationship may be quantified using statistical correlation measures such as the Pearson Linear Correlation Coefficient (PLCC), Spearman Rank Correlation, or other suitable metrics. The choice of statistical method may vary depending on the dataset characteristics or application requirements. Understanding this relationship can support decisions related to dataset curation, model selection, domain adaptation, or preprocessing strategies that aim to improve model robustness under varying visual conditions.

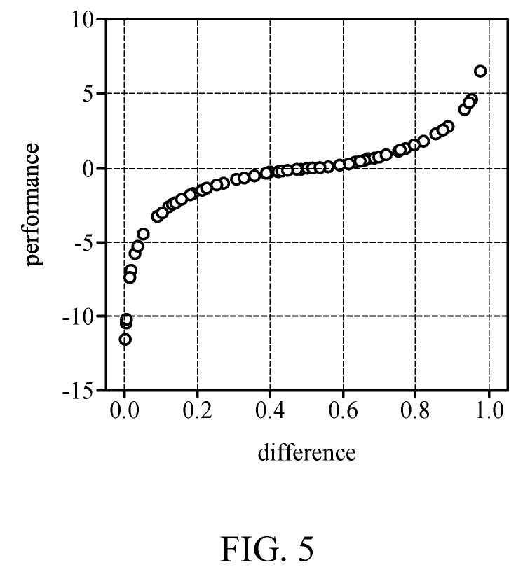

FIG. 5 is a graph illustrating an example of how the Spearman Rank-Order Correlation Coefficient (SROCC) can be applied to evaluate the relationship between variations in image statistics and model performance. In FIG. 5, the horizontal axis represents differences in image statistics, and the vertical axis represents object detection performance. The plotted data points demonstrate a monotonic relationship between the two variables, where the rank ordering of values on one axis corresponds consistently to the rank ordering on the other axis. In this example, the SROCC value is equal to 1, indicating a perfectly monotonic relationship, while the Pearson correlation is 0.88, reflecting a strong but not perfectly linear relationship.

The use of SROCC offers specific advantages when analyzing relationships that are not strictly linear. Unlike the Pearson correlation coefficient, which measures only linear dependence, SROCC evaluates whether a function is monotonic, meaning that as one variable increases, the other variable either consistently increases or consistently decreases. This allows for the detection of meaningful associations even in cases where the underlying functional form is nonlinear. Accordingly, the use of SROCC provides a more robust measure of association in real-world scenarios where the relationship between image statistics and model performance may not follow a linear pattern.

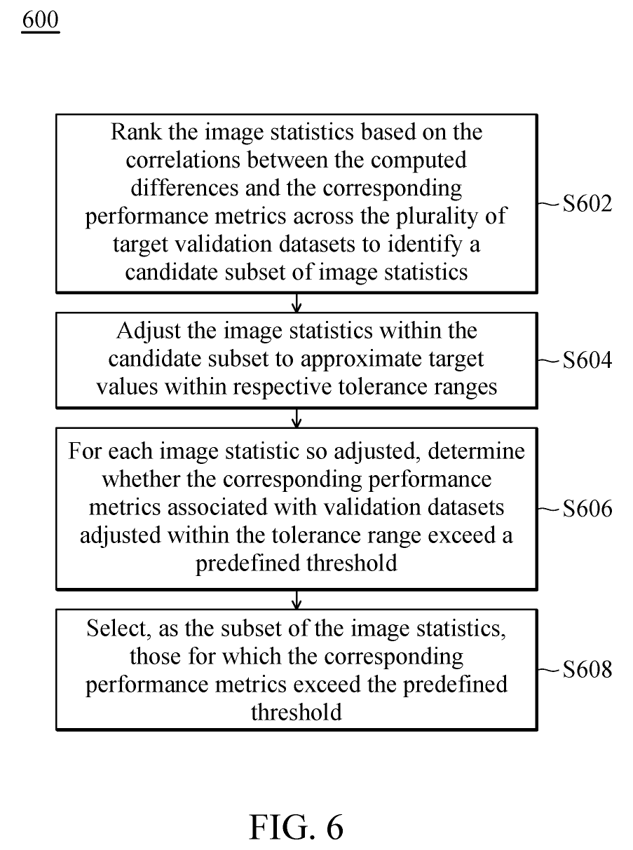

Referring to FIG. 6, a flow diagram is shown illustrating a process 600 for selecting a subset of image statistics. In this process, a series of steps may be executed by the processing unit 106 to identify and select the most relevant image statistics for subsequent image processing or analysis. The process 600 includes steps S602 through S608, which are described in detail below.

In step S602, the image statistics are ranked based on the correlations between the computed differences and the corresponding performance metrics across a plurality of target validation datasets, in order to identify a candidate subset of image statistics. Specifically, a predetermined number of top-ranked image statistics, determined according to the strength of their correlation with performance degradation or improvement, may be selected as candidates for further evaluation in subsequent steps.

In step S604, the image statistics within the candidate subset are adjusted to approximate target values within respective tolerance ranges. The tolerance range refers to an allowable deviation or margin around each target value, which defines the acceptable bounds within which the adjusted image statistics are considered sufficiently close to the desired reference values. The purpose of this step is to simulate the effect of image pre-processing on the target images, such that the selected statistics are aligned, within practical limits, to those observed in reference datasets. This enables the system to evaluate how reducing specific statistical differences may influence model performance, without requiring exact matching.

In step S606, for each adjusted image statistic, it is determined whether the corresponding performance metrics associated with the validation datasets, which have been adjusted within the specified tolerance range, exceed a predefined threshold. The predefined threshold represents a performance criterion that must be met or surpassed for an image statistic to be considered effective in improving or maintaining model performance. If the performance metric, such as mean Average Precision (mAP), exceeds the threshold after adjustment, it indicates that aligning the image statistic to the target value has a positive or sufficient impact on model accuracy. This step enables the system to filter out statistics whose adjustments do not meaningfully contribute to performance improvement under the given conditions.

In step S608, those image statistics for which the corresponding performance metrics exceed the predefined threshold are selected as the final subset of image statistics. This selection process enables the system to identify and retain only those image statistics that demonstrate a meaningful contribution to model performance improvement.

In some embodiments, the processing unit 106 may be further configured to evaluate each image statistic in the candidate subset using a coefficient of variation (CV). The coefficient of variation provides a normalized measure of dispersion relative to the mean of the statistic, allowing for the identification of unstable or highly variable statistics. If the CV of a given image statistic exceeds a predefined threshold, that image statistic may be excluded from the subset.

A high CV indicates that the values of a given image statistic fluctuate significantly across different datasets, suggesting a lack of consistency or predictability. Such variability may reduce the reliability of that statistic as a basis for image adjustment or performance prediction. Therefore, if the CV of a given image statistic exceeds a predefined threshold, that image statistic may be excluded from the subset. This filtering process improves the robustness of the selected image statistics by eliminating those with inconsistent behavior across datasets.

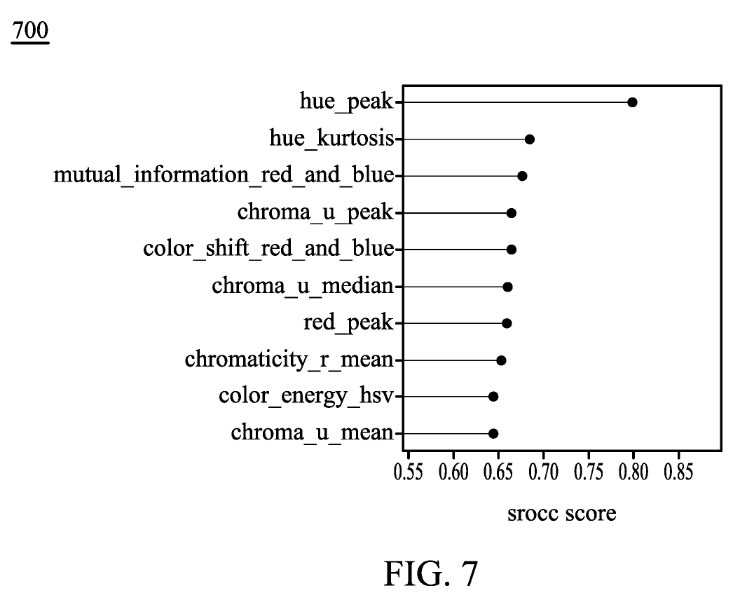

In some embodiments, the processing unit 106 may be further configured to generate a visual representation of the relationship between each image statistic and the corresponding performance metric across a plurality of validation datasets. This visual representation may include, for example, scatter plots, trend lines, or other graphical formats that illustrate how variations in individual image statistics correlate with changes in model performance. Referring to FIG. 7, a ranking 700 is illustrated, which presents the ordering of image statistics based on their correlation with model performance, as evaluated using Spearman’s Rank Order Correlation Coefficient (SROCC).

In this example, the top ten image statistics are ranked according to their SROCC scores, which indicate the strength of monotonic correlation with model performance. Among these, hue_peak demonstrates the highest SROCC score, suggesting that variations in the hue peak of the input images have the most significant impact on the model’s predictive performance. Other highly ranked image statistics include hue_kurtosis, mutual_information_red_and_blue, and chroma_u_peak, each showing a strong association with performance variation across validation datasets. The ability to visualize these rankings enables a user or system operator to intuitively interpret which image statistics are most influential, thereby guiding further optimization of pre-processing or model adaptation strategies.

The visual representation may be displayed on a display device, thereby allowing a user or system operator to intuitively interpret the influence of different image statistics on model performance.

In the inference phase, the processing unit 106 is further configured to apply the trained machine learning model to the pre-processed target images in order to perform inference. The parameters used for pre-processing the target images may be adjusted to reduce differences between the image statistics of the target images and the image statistics of images captured by the reference image-capturing device.

Reducing such differences helps align the input characteristics of the target images with those of the training data, thereby improving the reliability and accuracy of the model's inference results. Without such alignment, the model may produce suboptimal predictions due to distribution shift or domain mismatch between training and deployment environments.

In some embodiments, respective subsets of the image statistics are selected for corresponding image-capturing scenarios. Each image-capturing scenario may represent a specific condition under which the target images are captured, such as variations in lighting, exposure, environment, or camera settings. By selecting tailored subsets of image statistics for different scenarios, the system can more effectively adapt the pre-processing process to improve model robustness and accuracy.

In some embodiments, the processing unit 106 is configured to identify one or more image statistics associated with a given image-capturing scenario, and to adjust the identified image statistics to reduce the difference between the target images and the reference validation dataset. Different types of image statistics may be selected based on the characteristics of the image-capturing scenario. For example, luminance-related statistics may be selected for low-light scenarios, where underexposure can lead to loss of detail, increased noise, or uneven brightness distribution. By focusing on luminance statistics in such cases, the system can better correct brightness-related artifacts and enhance visibility, thereby improving model performance.

Similarly, saturation-related statistics may be prioritized for scenarios such as dusk or foggy environments, where color information tends to be muted or distorted due to atmospheric lighting conditions. Adjusting saturation and chromaticity statistics under these conditions helps restore color fidelity and distinguishability, which are important for tasks such as object detection or scene segmentation. In high-contrast environments, contrast-related statistics may be selected to manage overexposed highlights or deep shadows. This context-aware selection of image statistics enables more effective pre-processing tailored to the visual challenges present in each specific scenario, thereby enhancing the robustness and adaptability of the system.

In some embodiments, the processing unit 106 is configured to classify the image-capturing scenario by performing a sequence of logically connected operations. First, the system computes key statistical indicators from the target images, such as the mean luminance and the standard deviation of saturation. These two values respectively reflect the overall brightness level and the variation in color intensity within the scene. Next, the computed values are compared against predefined thresholds that correspond to known lighting conditions. If the luminance mean is below a certain level, the scene may be identified as low-light. On the other hand, if the luminance is moderate but the saturation variation is significantly reduced, the system may classify the scenario as dusk, where color tones are often uniformly muted. By interpreting these metrics in combination rather than isolation, the system can more accurately infer the image-capturing environment and apply scenario-specific image processing strategies accordingly.

Accordingly, the disclosed system enables the identification of key image statistics that are strongly correlated with object detection accuracy. By allowing for camera adjustment of these statistics, such as through ISP tuning system can optimize the camera’s imaging output so that the captured images conform to statistical requirements of object detection model. This approach improves detection performance without requiring retraining of the machine learning model, enhances model generalization, and increases the system’s flexibility and adaptability across diverse image-capturing scenarios and deployment conditions.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. An image pre-processing system for model performance optimization, comprising:
a reference image-capturing device, configured to capture a training dataset and a reference validation dataset;
a processing unit, in communication with the reference image-capturing device;
a storage unit, storing a computer program comprising instructions that, when executed by the processing unit, cause the processing unit to execute steps including:
training a machine learning model using the training dataset captured by the reference image-capturing device;
obtaining a plurality of validation datasets including the reference validation dataset and a plurality of target validation datasets;
analyzing relationships between image statistics and performance metrics, wherein the image statistics are derived from the validation datasets, and the performance metrics are derived from the validation datasets using the machine learning model;
selecting a subset of the image statistics based on the relationships corresponding to the image statistics; and
pre-processing target images captured by a target image-capturing device based on the selected subset of the image statistics.

2. The image pre-processing system as claimed in claim 1, wherein the processing unit analyzes the relationships between the image statistics and the performance metrics by executing steps comprising:
for each of the validation datasets, applying the trained machine learning model to compute the performance metric, and computing the image statistics from images in the validation dataset; and
for each of the image statistics, computing a difference between a representative value derived from the reference validation dataset and another representative value derived from each target validation dataset, and computing a correlation between the computed difference and the performance metrics across the plurality of target validation datasets, wherein the computed correlation is used to represent the relationships between the image statistic and the performance metrics.

3. The image pre-processing system as claimed in claim 2, wherein the processing unit selects the subset of the image statistics by executing steps comprising:
ranking the image statistics based on the correlations between the computed differences and the corresponding performance metrics across the plurality of target validation datasets to identify a candidate subset of image statistics;
adjusting the image statistics within the candidate subset to approximate target values within respective tolerance ranges;
for each image statistic so adjusted, determining whether the corresponding performance metrics associated with validation datasets adjusted within the tolerance range exceed a predefined threshold; and
selecting, as the subset of the image statistics, those for which the corresponding performance metrics exceed the predefined threshold.

4. The image pre-processing system as claimed in claim 3, wherein the processing unit is further configured to evaluate each image statistic in the candidate subset using a coefficient of variation (CV), and exclude any image statistic having the CV exceeding a predefined threshold.

5. The image pre-processing system as claimed in claim 3, wherein the processing unit is further configured to:
generate a visual representation of the relationship between each image statistic and the corresponding performance metric across the validation datasets; and
display the visual representation on a display device.

6. The image pre-processing system as claimed in claim 2, wherein each of the correlations between the computed differences and the performance metrics is calculated using Spearman’s Rank Order Correlation Coefficient (SROCC).

7. The image pre-processing system as claimed in claim 1, wherein the target validation datasets are captured by multiple image-capturing devices.

8. The image pre-processing system as claimed in claim 1, wherein the target validation datasets are obtained by applying a variety of image signal processing parameters to raw images captured by the reference image-capturing device.

9. The image pre-processing system as claimed in claim 1, wherein the processing unit is further configured to apply the trained machine learning model to the pre-processed target images to perform inference, wherein parameters used to pre-process the target images are adjusted to reduce differences between the image statistics of the target images and the image statistics of images captured by the reference image-capturing device.

10. The image pre-processing system as claimed in claim 9, wherein respective subsets of the image statistics are selected for respective image-capturing scenarios, wherein each image-capturing scenario corresponds to a condition in which the target images are captured.

11. The image pre-processing system as claimed in claim 10, wherein luminance-related statistics are selected for low-light scenarios, and saturation-related statistics are selected for dusk scenarios.

12. The image pre-processing system as claimed in claim 11, wherein the processing unit is configured to classify the image-capturing scenario by executing steps comprising:
computing a luminance mean and a saturation standard deviation from the target images;
comparing the computed luminance mean and saturation standard deviation to respective predefined thresholds; and
determining whether the image-capturing scenario corresponds to the low-light scenarios or the dusk scenarios based on the comparison.

13. The image pre-processing system as claimed in claim 10, wherein the processing unit is configured to:
identify one or more image statistics associated with the image-capturing scenario; and
adjust the identified image statistics to reduce a difference between the target images and the reference validation dataset.

14. The image pre-processing system as claimed in claim 1, wherein the image statistics comprise at least one selected from a group consisting of:
color characteristics,
texture characteristics,
brightness level,
contrast,
sharpness indicators, and
non-reference image quality assessment (NR-IQA) metrics.

15. The image pre-processing system as claimed in claim 1, wherein parameters used to pre-process the target images comprise at least one selected from a group consisting of:
gamma correction,
contrast enhancement,
sharpening level, and
noise reduction strength.

16. A computer-implemented method for optimizing model performance via image pre-processing, comprising:
training a machine learning model using the training dataset captured by a reference image-capturing device;
obtaining a plurality of validation datasets, wherein the plurality of validation datasets include a reference validation dataset captured by the reference image-capturing device and a plurality of target validation datasets;
analyzing relationships between image statistics and performance metrics, wherein the image statistics are derived from the validation datasets, and the performance metrics are derived from the validation datasets using the machine learning model;
selecting a subset of the image statistics based on the relationships corresponding to the image statistics; and
pre-processing target images captured by a target image-capturing device based on the selected subset of the image statistics.

17. The method of claim 16, wherein the step of analyzing the relationships between the image statistics and the performance metrics further comprises:
for each of the validation datasets:
applying the trained machine learning model to compute the performance metric using the processing unit; and
computing the image statistics from images in the validation dataset using the processing unit; and
for each of the image statistics:
computing a difference between a representative value derived from the reference validation dataset and another representative value derived from each target validation dataset using the processing unit; and
computing a correlation between the computed difference and the performance metrics across the plurality of target validation datasets using the processing unit, wherein the computed correlation is used to represent the relationships between the image statistic and the performance metrics.

18. The method of claim 17, wherein the step of selecting the subset of the image statistics further comprises:
ranking the image statistics based on the correlations between the computed differences and the corresponding performance metrics across the plurality of target validation datasets to identify a candidate subset of image statistics;
adjusting the image statistics within the candidate subset to approximate target values within respective tolerance ranges;
for each image statistic so adjusted, determining whether the corresponding performance metrics associated with validation datasets adjusted within the tolerance range exceed a predefined threshold; and
selecting, as the subset of the image statistics, those for which the corresponding performance metrics exceed the predefined threshold.

19. The method of claim 18, further comprising:
evaluating each image statistic in the candidate subset using a coefficient of variation (CV); and
excluding any image statistic having the CV exceeding a predefined threshold.

20. The method of claim 18, further comprising:
generating a visual representation of the relationship between each image statistic and the corresponding performance metric across the validation datasets; and
displaying the visual representation on a display device.

21. The method of claim 17, further comprising:
calculating each of the correlations between the computed differences and the performance metrics using Spearman’s Rank Order Correlation Coefficient (SROCC).

22. The method of claim 16, wherein the target validation datasets are captured by multiple image-capturing devices.

23. The method of claim 16, further comprising:
obtaining the target validation datasets by applying a variety of image signal processing parameters to raw images captured by the reference image-capturing device.

24. The method of claim 16, further comprising:
applying the trained machine learning model to the pre-processed target images to perform inference, wherein parameters used to pre-process the target images are adjusted to reduce differences between the image statistics of the target images and the image statistics of images captured by the reference image-capturing device.

25. The method of claim 24, wherein respective subsets of the image statistics are selected for respective image-capturing scenarios, wherein each image-capturing scenario corresponds to a condition in which the target images are captured.

26. The method of claim 25, wherein luminance-related statistics are selected for low-light scenarios, and saturation-related statistics are selected for dusk scenarios.

27. The method of claim 26, further comprising classifying the image-capturing scenario by executing steps comprising:
computing a luminance mean and a saturation standard deviation from the target images;
comparing the computed luminance mean and saturation standard deviation to respective predefined thresholds; and
determining whether the image-capturing scenario corresponds to the low-light scenarios or the dusk scenarios based on the comparison.

28. The method of claim 25, further comprising:
identifying one or more image statistics associated with the image-capturing scenario using the processing unit; and
adjusting the identified image statistics to reduce the difference between the target images and the reference validation dataset using the processing unit.

29. The method of claim 16, wherein the image statistics comprise at least one selected from a group consisting of:
color characteristics,
texture characteristics,
brightness level,
contrast,
sharpness indicators, and
non-reference image quality assessment (NR-IQA) metrics.

30. The method of claim 16, wherein parameters used to pre-process the target images comprise at least one selected from a group consisting of:
gamma correction,
contrast enhancement,
sharpening level, and
noise reduction strength.
